(19) United States
(12) Patent Application Publication
(10) Pub. No.: US 2013/0177303 A1
(43) Pub. Date: Jul. 11, 2013

(54) SURVEILLANCE TRAILER WITH TILTING CAMERA SUPPORT POLE

(71) Applicants: James PIERCE, Cumming, GA (US); Thomas E. BROWN, Cumming, GA (US); Antonio MOSQUERA, Cumming, GA (US)

(72) Inventors: James PIERCE, Cumming, GA (US); Thomas E. BROWN, Cumming, GA (US); Antonio MOSQUERA, Cumming, GA (US)

(21) Appl. No.: 13/346,943

(22) Filed: Jan. 10, 2012

(51) Int. Cl. G03B 17/56

(52) U.S. Cl. 396/427

(57) ABSTRACT

A self-contained surveillance trailer includes a wheeled chassis for selective movement over and resting atop the ground and an electronics enclosure mounted atop the wheeled chassis. Surveillance electronics are mounted within the electronics enclosure. A camera support pole is pivotally mounted atop the wheeled chassis for pivotal motion between a raised position and a lowered position and a surveillance camera is mounted to the camera support pole. A brace extends between the wheeled chassis and the camera support pole for bracing the camera support pole in position. A roller is positioned between the camera support pole and the brace to allow the brace to engage the camera support pole at different positions along the camera support pole as the camera support pole is raised and/or lowered. One or more locks are provided for locking the camera support pole in the raised position.

### TECHNICAL FIELD

The present invention relates generally to surveillance equipment and more particularly to a portable surveillance apparatus.

### BACKGROUND OF THE INVENTION

It often occurs that a need arises to surveil a location that is not near a building or other source of electric power. In such a situation, a portable surveillance apparatus can be of substantial utility.

### SUMMARY

In a first preferred example form, the present invention comprises a self-contained surveillance trailer. The trailer includes a wheeled chassis for selective movement over and resting atop the ground and an electronics enclosure mounted atop the wheeled chassis. Surveillance electronics are included, including a portable power supply, at least some of which is mounted within the electronics enclosure. A camera support pole is tiltably mounted atop the wheeled chassis for tilting motion between a raised position and a lowered position and a surveillance camera is mounted to the camera support pole.

Optionally, a brace extends between the wheeled chassis and the camera support pole for bracing the camera support pole in position. Also optionally, a roller is positioned between the camera support pole and the brace to allow the brace to engage the camera support pole at different positions along the camera support pole as the camera support pole is raised and/or lowered.

Preferably, one or more locks are provided for locking the camera support pole in the raised position. In one form, a lock is provided for locking the camera support pole in the raised position and the lock engages and operates on the brace to fix the camera support pole in position. Optionally, the lock for locking the camera support pole in the raised position comprises a lock pin which engages the brace to fix the camera support pole in the raised and lowered positions.

In one form, the camera support pole is hingedly mounted relative to the wheeled chassis. Optionally, a deck is mounted to the wheeled chassis and the camera support pole is hingedly mounted to the deck.

Optionally, the camera support pole is mounted to a hinge plate which in turn is hingedly mounted relative to the wheeled chassis and the trailer further includes an optional lock for locking the camera support pole in the raised position, the lock comprising a removable pin for engaging the hinge plate for locking the camera support pole in the raised position.

With this arrangement, the trailer can be configured for transport by lowering the cameral support pole and locking the camera support pole in the lowered position. Once trailered to the desired location, the pole can be erected and locked in place for use. This allows the use of a pole that otherwise might not fit under overpasses and bridges (allowing a taller, more effective pole).

### BRIEF DESCRIPTION OF THE DRAWING FIGURES

FIG. 1 is a schematic perspective view of a portable surveillance trailer according to a first preferred form of the present invention.

FIG. 2 is a schematic sectional side elevation view of the portable surveillance trailer of FIG. 1.

FIG. 3A is a schematic perspective view of a hitch portion of the portable surveillance trailer of FIG. 1 in an alternative form.

FIG. 3B is a schematic perspective view of a hitch portion of the portable surveillance trailer of FIG. 1.

FIG. 4 is a schematic perspective view of a chassis portion of the portable surveillance trailer of FIG. 1.

FIG. 5 is a schematic perspective view of the portable surveillance trailer of FIG. 1 attached to a vehicle.

FIG. 6 is a schematic electrical diagram of a solar power recharging circuit of the portable surveillance trailer of FIG. 1.

FIG. 7 is a schematic functional diagram of a connection of the portable surveillance trailer of FIG. 1 to the internet via cellular communication.

FIG. 8 is a schematic side view of a portable surveillance trailer according to another embodiment of the present invention.

FIG. 9 is a schematic side view of an optional camera post support assembly of the portable surveillance trailer of FIG. 1.

FIG. 9A is a detailed side sectional view of an upper portion of the camera post support assembly of FIG. 9.

FIG. 9B is a detailed side sectional of a lower portion of the camera post support assembly of FIG. 9.

FIG. 10 is a detailed perspective view of a lower portion of the camera post of FIG. 1, shown in an erect, upright position.

FIG. 11 is a detailed perspective view of a lower portion of the camera post of FIG. 1, shown in lowered position.

FIG. 12 is a detailed perspective view of a brace portion of the camera post of FIG. 1.

FIG. 13 is a detailed schematic view of the brace portion of FIG. 12, shown in an erect, upright position in solid lines and in a lowered position in dashed lines.

FIG. 14 is a detailed perspective view of an upper portion of the brace engaging the camera post of FIG. 1.

FIG. 15 is a detailed perspective view of an alternative version of the lower portion of the camera post of FIG. 1, shown in an erect, upright position.

### DESCRIPTION OF EXAMPLE EMBODIMENTS

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

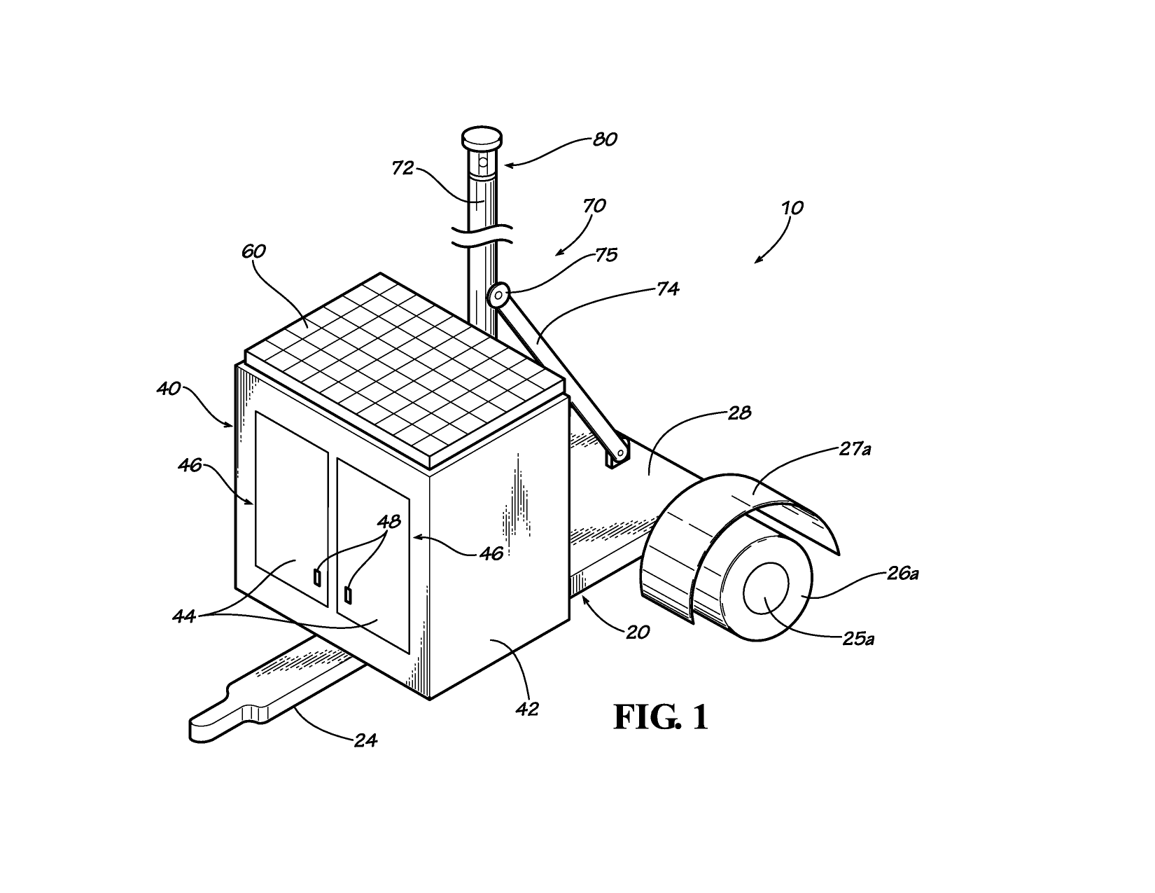

With reference now to the drawing figures, wherein like reference numbers represent corresponding parts throughout the several views, FIGS. 1-4 show a self-contained surveillance trailer 10 according to a first example embodiment of the present invention. The self-contained surveillance trailer 10 is transportable by a vehicle V (such as a car or truck) and can be placed in any area where surveillance or monitoring is needed. In example embodiments, the self-contained surveillance trailer 10 comprises a chassis assembly 20, a housing assembly 40, and a camera support post assembly 70.

The chassis assembly 20 comprises a support frame or main structure of the trailer 10. In example embodiments, the chassis assembly 20 includes a plurality of tubular members joined together, for example by welding together into a rigid ladder frame (see FIG. 4). A pair of longitudinal rails 22a, 22b extend front to back along the sides of the chassis and are secured to outer ends of a front cross member 23a and a rear cross member 23b. A front side of the front cross member 23a includes a forwardly extending hitch or tongue 24. The hitch 24 generally extends parallel to the longitudinal rails 22a, 22b and is welded to the lengthwise mid-point of the front cross member 23a. In preferred embodiments, the longitudinal axes of the tubular members discussed thus far (longitudinal rails 22a, 22b, front and rear cross members 23a, 23b, and hitch 24) are positioned within a common horizontal plane.

An axle tube 21 extends underneath and beyond the rails 22a, 22b and is welded to the bottom sides thereof. The axle tube 21 is generally parallel to the front and rear cross members 23a, 23b and is positioned in the rear half of the chassis assembly 20 along the length of the longitudinal rails 22a, 22b.

Preferably, the plurality of square metal tubes making up the chassis assembly 20 are secured to each other by welds. Alternatively, the chassis elements can be removably secured to each other by one or more bolts, screws, pins or other connectors. In additional example embodiments, the tubular members can be constructed of wood, steel, composites (i.e. carbon fiber or fiber glass), hard plastics, aluminum, other known materials or combination herein. Further, the tubular members can comprise oval, elliptical, circular, rectangular, symmetrical (i.e. c-channel or I-beam) or non-symmetrical cross-sectional profiles.

The ends of the axle tube 21 support unshown axles to which are mounted wheels 25a, 25b with pneumatic tires 26a, 26b. Alternatively, one long axle can span the entire axle tube 21, if desired. The wheels are rotatably mounted to the ends of the axles. Optionally, the chassis 20 can comprise fenders 27a, 27b and a deck 28. The fenders generally mount to the outer sides of the longitudinal rails 22a, 22b proximal to the axle tube 21, extending over and above tires 26a, 26b. The deck 28 mounts to the top surface of the chassis assembly 20 and comprises a substantially flat, thick piece of sheet metal. The deck 28 can have one or more openings therein and can be constructed of wood, steel, aluminum, plastic, composites, other materials or combinations herein.

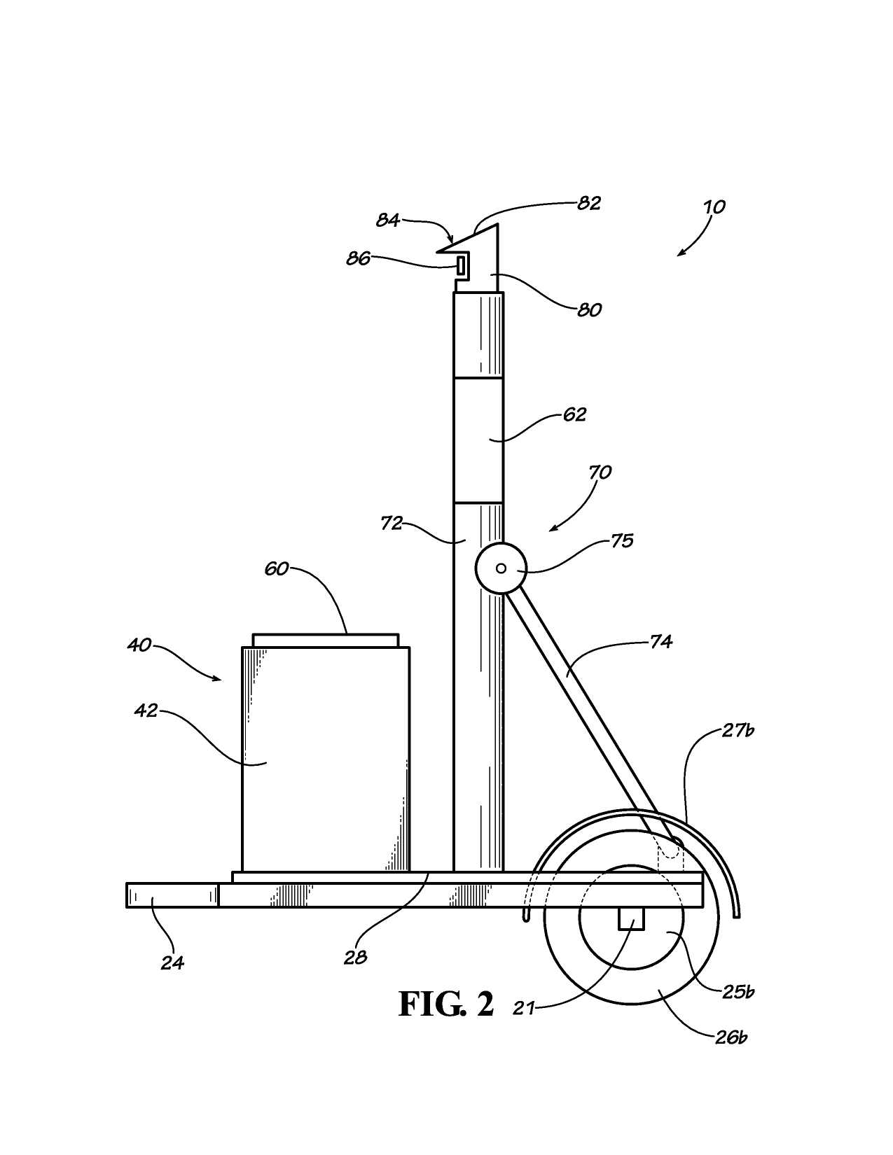

As depicted in FIGS. 1-2, the housing assembly 40 and the camera support post assembly 70 are mounted atop the chassis 20 and optional deck 28. In example embodiments, a housing or electronics cabinet 42 is mounted atop the front half of the chassis 20. The front side of the housing 42 comprises doors 44, each movably mounted to the housing by a hinge, such as hinge 46. The hinges preferably are piano hinges that extend along the length of the doors 44. The doors 44 pivot about the hinges 46 and can be opened and/or closed by handles 48. In additional example embodiments, the doors 44 can include an unshown separate lock mechanism and the handles 48 can be lockable, for example by requiring key to lock and/or unlock the doors 44 of the electronics cabinet 42.

The top side of the housing 40 includes a first solar power panel 60 for powering the surveillance electronics. The first solar power panel 60 is generally positioned parallel to the ground and has a flat contour substantially similar to the top side of the electronics cabinet 42.

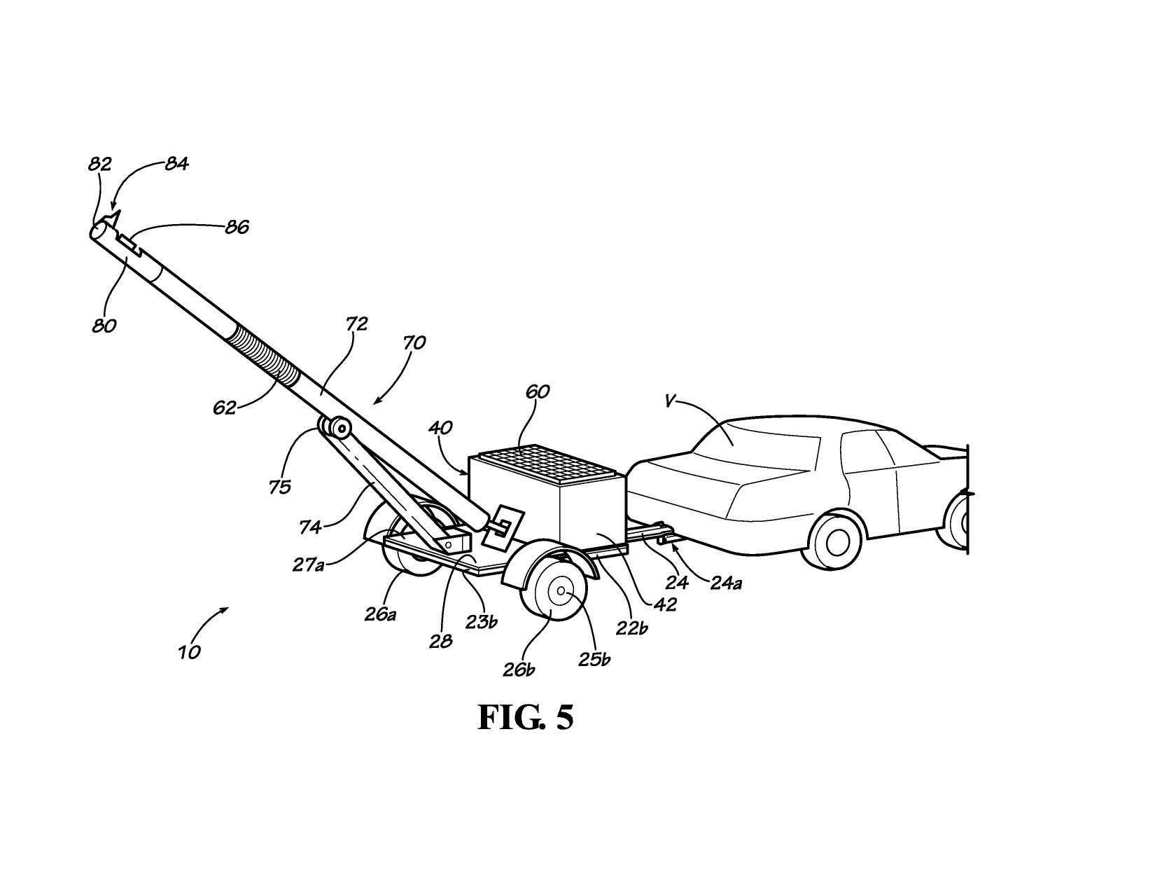

The camera support post assembly 70 generally comprises an elongated camera support post 72 and a strut or stabilizer 74. A first end of the camera support post 72 is pivotally/tiltably mounted atop the chassis assembly 20. The camera support post 72 can selectively pivot/tilt about its first end between a vertical position (see FIGS. 1-2) when operating the surveillance system and a lowered rearward angled position (see FIG. 5) when transporting the trailer. In either position, the camera support post 72 is engaged by and stabilized by the strut 74. A first end of the strut 74 is pivotally mounted atop the chassis assembly 20 and a second end bears a roller 75 (such as a bow roller) that contacts the outer surface of the support post 72. A removable pin near the lower (first) end of the strut secures the strut in one of two positions by preventing rotation of the strut. A strap secures the upper (second) end of the strut to the 74 camera support post 72.

A second solar power panel 62 is positioned on the support post 72. Preferably, the second solar power panel 62 is wrapped about the support post 72 in a vertical or upright orientation relative to the ground when operating the surveillance system. Generally, the energy obtained from the solar power panels 60, 62 charge the portable power supply stored within the electronics cabinet 42. In additional example embodiments, the energy may be optionally provided by a generator and/or 120 volt electrical outlet.

A removable camera mount 80 is pivotally or rotatably mounted to the second (upper) end of the camera support post 72. The camera mount 80 is generally hollow and comprises a closed end having a roof 82. In preferred embodiments, the roof 82 is angled and comprises an overhang 84 extending beyond the outer surface of an inset camera 86. Preferably, the camera mount 80 and support post 72 have a substantially similar cross-sectional shape and are aligned coaxially. In additional example embodiments, the camera mount 80 can pivot 360 degrees about the support post 72 and may include a motor to rotate the camera mount 80 to a particular orientation and fix it there. A front side of the camera mount 80 below the roof 82 comprises an opening or niche for mounting the inset camera 86 therein. By positioning the inset camera 86 within the niche, the camera is less obvious to a passerby.

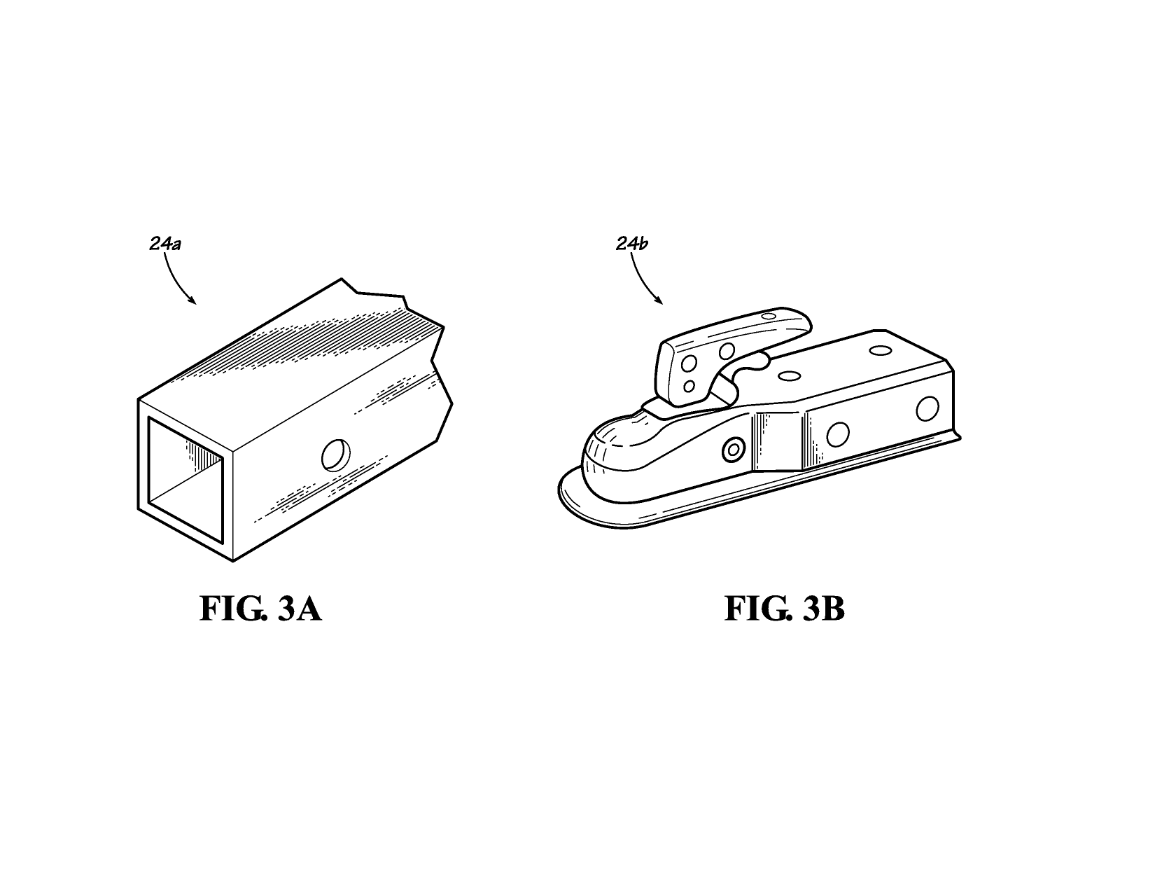

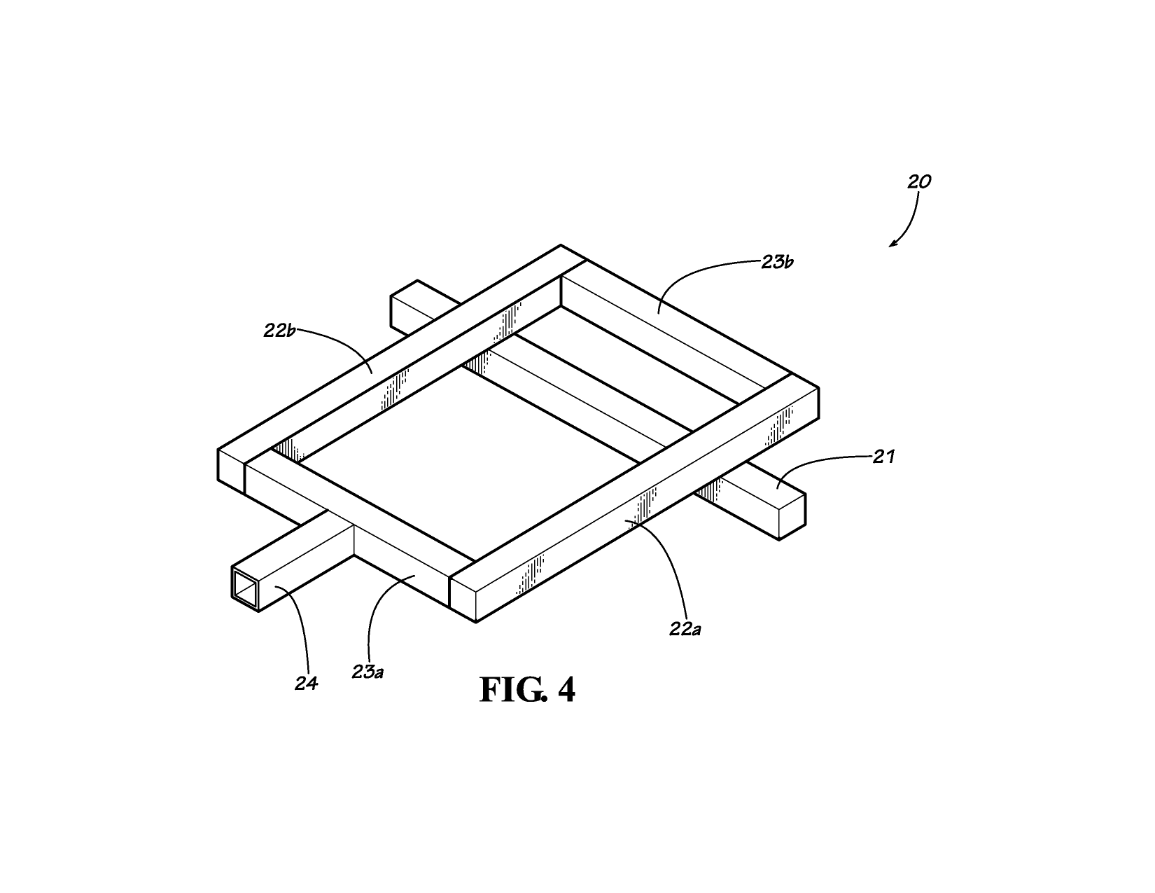

As depicted in FIG. 3, the connection between the vehicle V and the self-contained surveillance trailer 10 can take various forms. In one example embodiment, a receiver hitch 24a is coupled to the vehicle V intended to transport the surveillance trailer 10 (see FIG. 3A). An assembled ball mount and trailer hitch ball (unshown) mounts to the receiver hitch 24a and is secured by engaging an (unshown) removable hitch pin. A tongue 24b (see FIG. 3B) is secured to the hitch 24 of the trailer 10 and couples to the trailer hitch ball (see FIG. 5). In additional example embodiments, the trailer hitch ball may directly mount to the rear of the vehicle, omitting the receiver hitch 24a and ball mount. In the same manner, the tongue 24b couples to the trailer hitch ball.

In an exemplary commercial application, the chassis 20 is approximately 4′ in length by approximately 4′ in width. The electronics cabinet 42 is approximately 24″ in depth by approximately 24″ in height by approximately 48″ in width. The camera support post 72 is a cylindrical tube with a diameter of approximately 6⅞″ and is approximately 10.5′ in length. The power supply comprises four 12 volt DC, 225 amp hour, gelled-electrolyte batteries. Those skilled in the art will appreciate that the above dimensions and electronics can be varied as desired.

In the exemplary commercial application, the first solar power panel 60 is a 90 watts panel with a width of approximately 21.8″ and a length of approximately 47.2″. The second solar power panel 62 is a 68 watt panel with a width (flat) of approximately 21.6″ and a length of approximately 90 inches. Those skilled in the art will recognize that solar panels of greater or lesser wattage can be employed, as desired. It is contemplated that the first solar panel 60 functions as an primary power charging source, while the second solar panel 62 functions as the secondary power source, but this is not a significant distinction or consideration, as the relative power outputs could be reversed. While a relatively short solar power panel wrap 62 is shown, those skilled in the art will appreciate that the length of the solar power wrap 62 can be varied as desired. Moreover, while the two solar panels are shown and described in this example embodiment as being perpendicular, other, less than perpendicular relative orientations can be used. Indeed, the orientation of the two panels need not be perpendicular to each other. Also, one or the other or both of the panels could be oriented to take advantage of the local latitude (and thus the angle of the sun in the sky). For example, the more or less horizontal solar power panel 60 can be angled upwardly at an angle corresponding to the local latitude so that the sun's energy hits the panel at the most effective angle of incidence (as perpendicularly as possible). To this end, it can advantageous to include a turntable so that the angled solar panel can be pointed south (north for the southern hemisphere).

With these arrangements, one or the other or both of the solar power panels is situated and oriented to collect solar energy from the sun throughout the day. For example, in the morning when the sun is low in the sky, the vertical panel is well situated to collect solar energy (while the horizontal solar power panel is less well situated). As the sun moves high overhead during the middle of the day, the horizontal solar power panel becomes more productive (and the vertical solar power power panel becomes less productive). As the sun drops from overhead toward the setting horizon, once again the vertical solar power panel becomes more productive, while the horizontal solar power panel becomes less productive. By including both a vertical and horizontal solar power panel, the present invention captures a greater amount of solar power throughout the day as the sun goes through its apparent motion in the sky. This helps to provide a more consistent power charge and tends to maximize the collected solar energy, regardless of the time of day (and sun position).

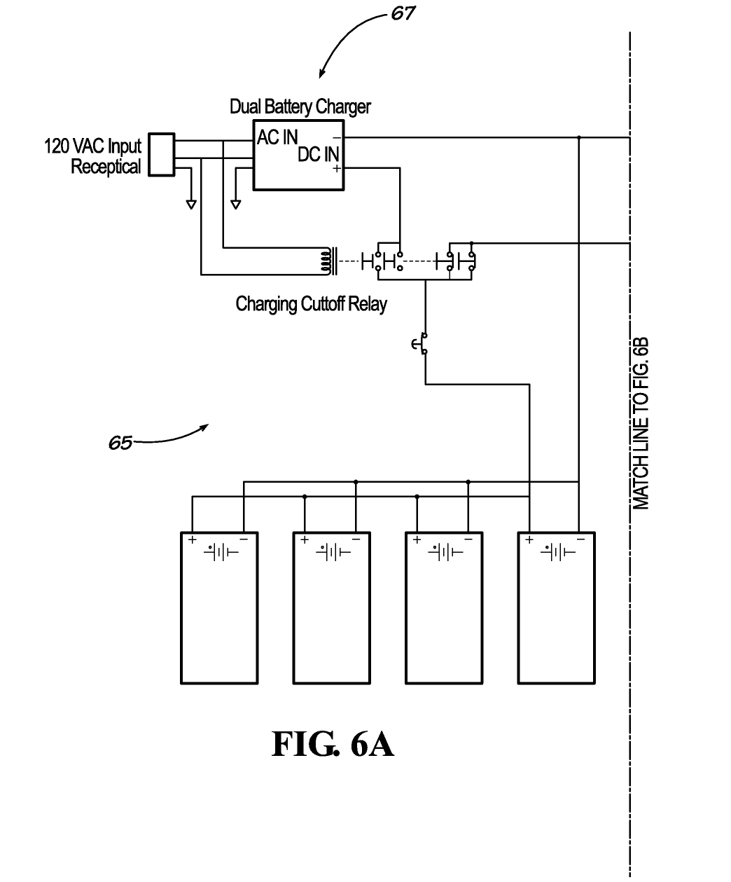

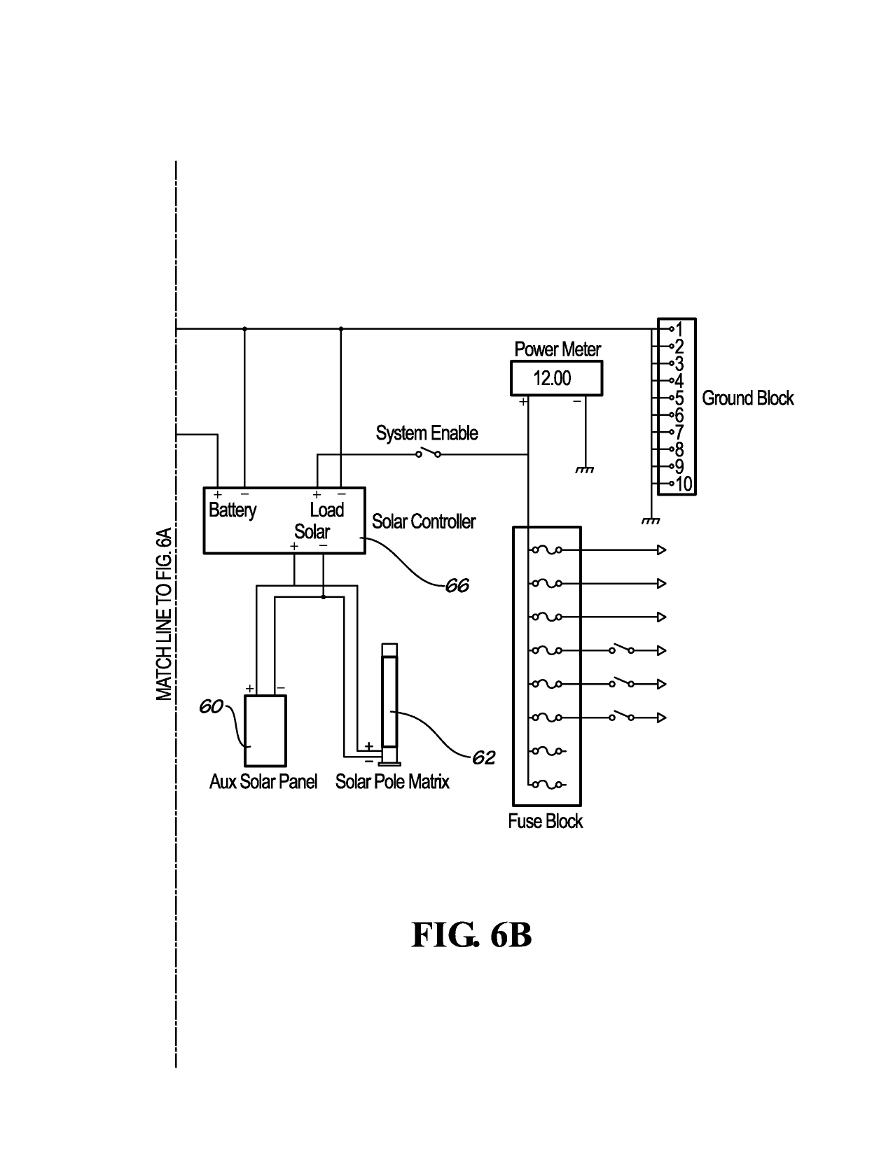

FIG. 6 shows a power charging circuit 65 for harnessing the power of the two solar power panels 60, 62 and using that electric power to maintain the electric charge of the four batteries B1, B2, B3, and B4. The electric power output of the two solar panels 60, 62 is ganged together and delivered to a Solar Controller 66, from whence it is delivered to the Load and to a Dual Battery Charger 67. Those skilled in the art will appreciate that other circuits can be employed to harness the outputs of the two solar power panels. Also, while two such panels are shown in the figures, more than two can be employed.

The camera assembly 86 can take various forms. In one preferred form, the camera assembly 86 has five camera sensors integrated into a single housing. In the preferred example embodiment, the camera assembly is an “A7-180” model Scallop Imaging camera assembly from Tenebraex Corporation of Boston, Mass. Those skilled in the art will recognize that other camera systems can be employed as well. Such a camera system 86 is a seven megapixel video camera that delivers one 720p HD frame that combines a seamlessly stitched, undistorted 180° view sized to fit within the frame, along with up to four separate detail views from the full 7 megapixel resolution. Such a camera system has an effective field of view of about 180 degrees by 48 degrees, a maximum frame rate of 15 fps, and has an output of 640×480 pixels (NTSC). Thus, the data rate for streaming such video, if not compressed, is about 4.6 megapixels per second (4,600 kps).

The example camera assembly 86 uses a 7 megapixel staring array to produce a 180×48 field of view, non-fisheye, panoramic video. Its staring array has the equivalent resolution (i.e., pixels on target) of 23 standard VGA cameras. The camera system's internal imaging engine presents the user with a 180 degree view plus up to three 8× zoom detail views packaged into one NTSC frame that can be sent over any standard CCTV analog network. Each of the zoom details can be under independent control using standard Pelco-D commands over RS485. Advantageously, the example camera is solid state, thus it has no moving parts to fail and require service.

The example camera assembly includes a base enclosure for housing electronics and a faceted, scalloped camera housing which houses multiple video sensors. Preferably, the camera assembly 86 includes five (5) such sensors, with the distal ones of the cameras pointed oppositely to one another (180 degrees apart), while the central camera is pointed perpendicular thereto. The remaining two intermediate cameras are oriented at 45 degrees relative to the distal cameras (half way between the end cameras and the central camera).

Moreover, the video output from the camera system 86 is provided through cabling to an optional video enhancer module (housed within the housing 40) and then on to a video encoder (with a wireless modem, both also protected within the housing 40) via cabling. Alternatively, the optional video enhancer module can be omitted and the video output from the camera system can be cabled directly to a video encoder/wireless modem.

Preferably, the output signal of the camera 86 is highly compressed by the video encoder (video processor), to the extent that the compressed signal can be sent over relatively low bandwidth wireless networks, like cellular telephone networks. The compressed signal is then uploaded to the wireless network from where it can be relayed to a server, such as an internet server from where it can be accessed, viewed, manipulated and further used by authorized personnel. Such authorized personnel need not be proximate to the surveillance equipment at all. The use of cellular networks, paired with the portable, self-sufficient nature of the surveillance trailer, renders a highly effective and useful system.

Preferably, the video processor collects the outputs of the plurality of fixed digital cameras and integrates the outputs of the plurality of fixed digital cameras into an integrated low-bandwidth video signal having a wide view and multiple narrow views. Preferably, the video processor's low-bandwidth video signal has a bandwidth of about 6 kbps or more, which is low enough to be accommodated on cellular networks. Optionally, the video processor dynamically monitors available bandwidth over the cellular network and adjusts the bandwidth of the low-bandwidth video signal so as to not exceed the available bandwidth over the cellular network that is then available. While digital cameras are the preferred camera type, those skilled in the art will appreciate that analog cameras can be employed.

Also, the other electronic equipment can be housed within the housing 40, including the batteries, as well as the video encoder and the solar charging module. Such electronic hardware may include a video compression card or other graphics apparatus to convert the video from the camera assembly 86 to data to be transmitted over a computer communications network or a video enhancement card to create a higher resolution video. The hardware may also include a wireless, cellular modem or other wireless transmission device that may use a Bluetooth or Wi-Fi protocol with which to communicate with a computer communications network. Such hardware may also include multiple batteries and a transformer such that the batteries may be charged by solar cells on the outside of the structure. Moreover, in those circumstances where a ready source of 120 VAC is available, a connection can be provided to a building electric service or other electrical source. A digital video recorder may also be included as hardware located at the surveillance structure, or it may be located on the premises with the monitoring station, which is discussed below.

One preferred form of the video encoder is a combined video encoder with built-in wireless modem. Such a unit is presently available from Essential Viewing of Rexford, N.Y. and known as the model TVI C300. The TVI C300 video encoder is a small, low-power unit which allows one to view high quality real-time video, despite low bandwidth. Using the built-in wireless modem, the image quality is relatively high. The video encoder's wireless modem provides access to various commercially available cellular networks, including GPRS, 3G, HSDPA, EDGE and CDMA. It also can communicate via satellite phone, IP radios, the Internet using ADSL, etc. The unit also benefits from a low power requirement of less than 6 watts (0.1 watt when on standby), which can be helpful when relying on battery power or solar power. In addition, the video encoder supports two way audio transmissions to enhance the surveillance capabilities of the system.

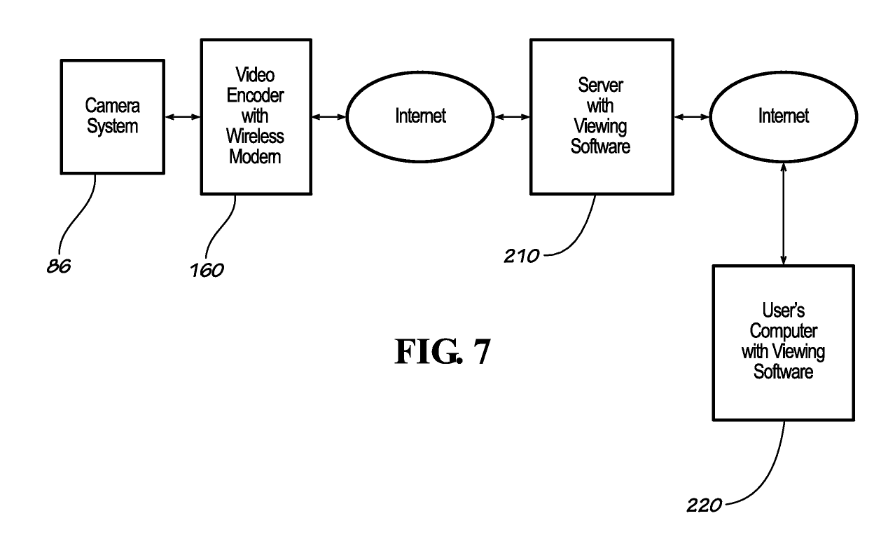

FIG. 7 is a schematic, functional diagram showing how the surveillance system of FIG. 1 operates to upload the video streams to a server on the internet and to provide access to the same by a user with a computer connected to the internet. As shown in this figure, the camera system 86 is coupled to the video encoder/wireless modem 160. The wireless modem 160 uploads the video to an internet-based server 210 where software manages, stores, and makes the video available to authorized users. The authorized users can access the internet-based server 210 by accessing the internet with a computer 220 loaded with appropriate viewing software. Optionally, a video enhancer module can be interposed between the camera system 103 and the video encoder/wireless modem 160. Optionally, a video enhancer module can be interposed between the video encoder/wireless modem 160 and the internet. Alternatively, a video enhancer module can be interposed between the internet-based server 210 and the user computer 220. The communication from the wireless modem 160 to the internet can be accomplished with a 2G or 3G air card. The communication from the internet to the server typically is facilitated with a T1 or T3 line. The communication from the user computer 220 to the internet can be accomplished by any number of known technologies.

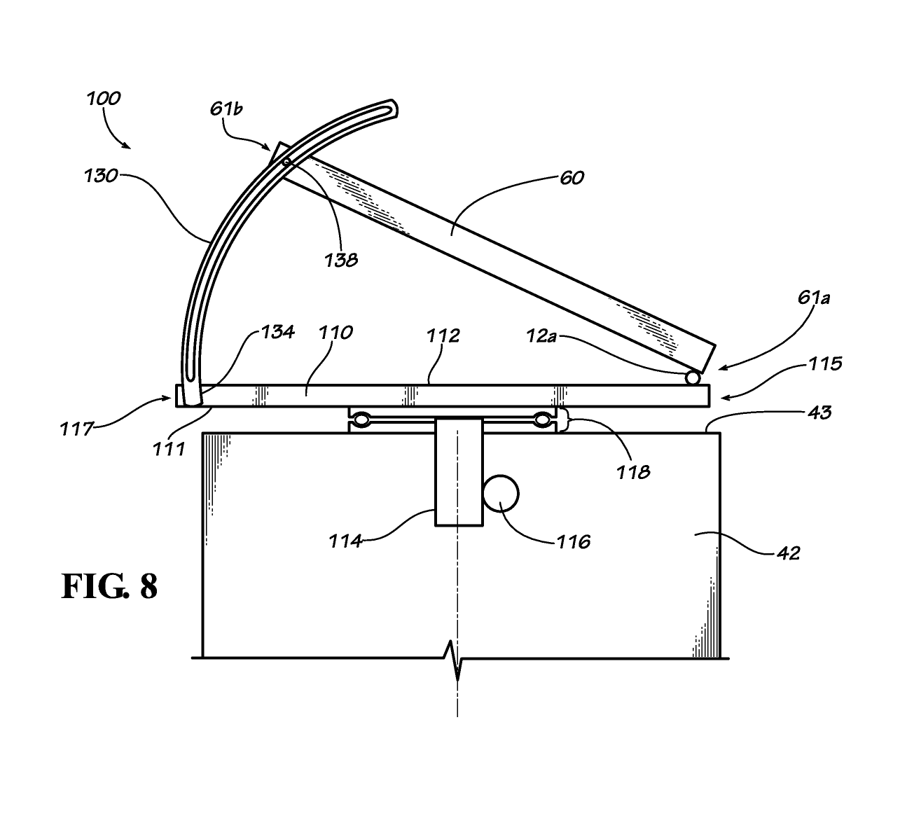

FIG. 8 shows an optional tilting and pivoting turntable arrangement for maximizing the energy capture by the more or less horizontal solar power panel. Generally speaking, the arrangement of FIG. 8 utilizes an “alt-azimuth” style of mount. In this additional example embodiment, the first solar power panel 60 comprises a azimuth-altitude mount or dual axis mount 100 to maximize the collection of solar energy from the sun for charging the portable power supply, for example by minimizing the angle of incidence between the ray incidence of the sun and solar panel 60. As depicted in FIG. 8, the dual axis mount 100 is rotatably mounted atop the electronics cabinet. A support platform 110 is positioned proximal and parallel to the top side 43 of the electronics cabinet 42 and has a flat contour substantially similar to the first solar power panel 60. A first pivot axle (for horizontal adjustment), such as shaft 114, is mounted to the bottom side 111 of the support platform 110 and extends through a mounting hole on the top side 43 of the electronics cabinet 42. Preferably, the shaft 114 is mounted near the center of mass of the support platform 110. A two-piece bearing assembly 118 is mounted to the top side 43 of the electronics cabinet 42 and the bottom side 111 of the support platform 110 to support the support platform and to provide smooth movement when pivoting and/or rotating the support platform. In additional example embodiments, a motor 116 (such as a DC or stepper motor) is mounted within the electronics cabinet 42 and can pivot and/or rotate the support platform 110. Preferably, the motor 116 is connected to the shaft 114 by a belt or gears.

A top side of the support platform has a hinge 120 and a slotted fixation bracket 130 for mounting the first solar power panel 60. The hinge preferably is a piano hinge that extends along the length of a first end 115 of the support platform 110. The slotted fixation bracket 130 mounts to a second end 117 of the support platform 110 and extends in arcuate direction having a radius substantially equal to the width of the solar power panel 60. A first end 61a of the first solar power panel 60 mounts to the hinge 120 and a second end 61b mounts to the slotted fixation bracket 130. Thus, the first solar power panel can pivot from a substantially horizontal position, in which the panel sits near and parallel to the top surface of the electronics cabinet 42, to an angled position relative to the top surface 112 of the support platform 110. The slotted fixation bracket 130 can be made long or short, as desired and tends to limit the maximum travel (angle) of the solar power panel 60. A slotted fixation bracket long enough to allow the solar power panel to be tilted up about 45 degrees is preferred.

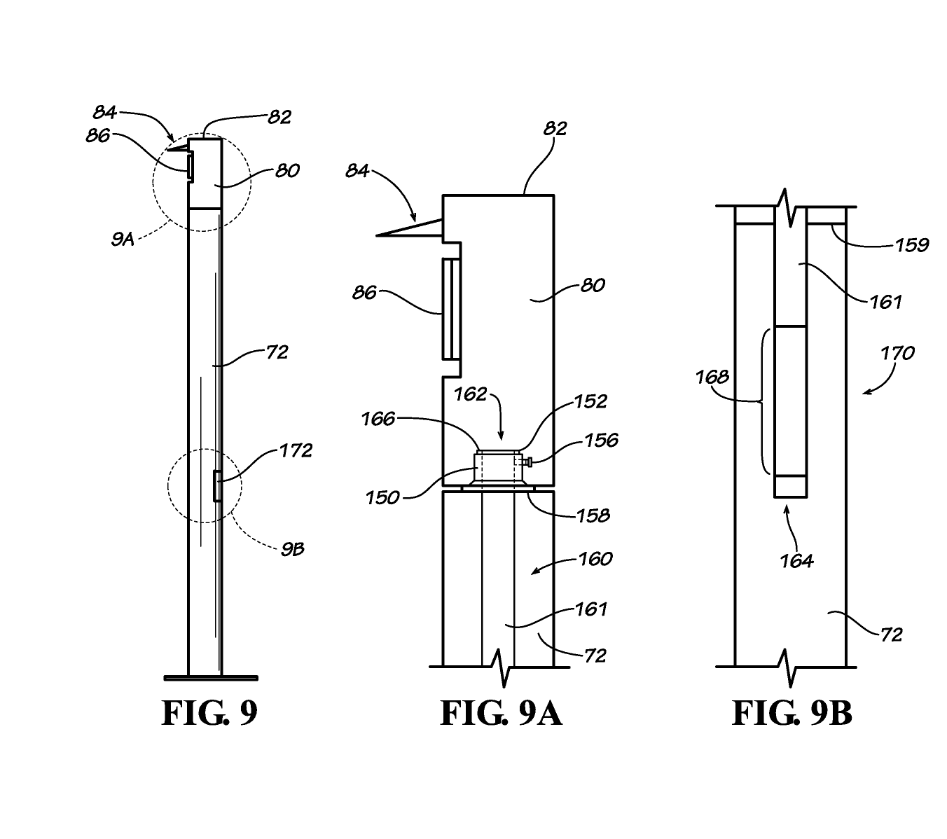

FIG. 9 shows an optional pivoting shaft mechanism or arrangement for adjusting the removable camera mount 80 to a particular orientation. As shown in this figure, the removable camera mount 80 is rotatably mounted to the camera support post 72 and a pivoting shaft arrangement 160 is housed therein. The pivoting shaft arrangement 160 is mounted to the removable camera mount 80 and can pivot 360 degrees about its axis of elongation within the camera support post 72. The internal bottom portion of the removable camera mount 80 comprises an integrally connected ring 150 that is axially aligned with the longitudinal axis of the camera mount 80 (see FIG. 9A). The ring 150 is mounted within the internal cavity of the camera mount 80 and is axially aligned with an aperture at the bottom portion of the camera mount 80. Further, an additional aperture is provided on the second (upper) end of the camera support post 72. An elongate shaft 161 extends from a first end 162 proximal the top side 152 of the ring 150, through the camera mount aperture and second (upper) end camera support post aperture, to a lower end 164 proximal the first end of the camera support post 72. Preferably, the apertures receiving the elongate shaft therethrough have a substantially similar contour to each other and to the contour of the ring 150. To prevent downward vertical movement of the shaft 161, a stopper ring or grommet 166 is mounted to the first end 162 of the shaft 161. Preferably, a portion or all of the grommet 166 extends beyond the contour of the internal channel of the ring 150 and continuously abuts the top side 152 of the ring 150. Further, a set screw or setting pin 156 is provided on a side of the ring 150 and can engage the shaft 161 therein, in which the engaged setting pin 156 locks the shaft 161 to the ring 150, and any rotation of the shaft 161 effectively causes the camera mount 80 to rotate in the same manner, direction and degree. Optionally, a slip ring 158 can be placed between the bottom side of the camera mount 80 and the top (upper) side of the camera support post 72 to reduce the friction between the two.

As shown in FIG. 9B, a side of the camera support post 72 comprises an opening or niche 170 for accessing and manually pivoting the lower end 164 of the elongate shaft 161. Preferably, the opening 170 is approximately 3.5′ above the first end of the camera support post 72 and is large enough for a hand of the user or operator to grasp and pivot the elongate shaft 161. As depicted in FIG. 9, the opening 170 can be covered by a door or closure 172 for limiting access to the shaft and keeping the pivoting shaft arrangement 160 out of the weather. For manually pivoting the shaft 161, the second end 164 of the shaft 161 can bear a knurled surface 168. The knurled surface 168 provides a rough surface for firmly grasping the second end 164 of the shaft 161, thereby easily pivoting the mounted removable camera mount 80 to a particular orientation. Additionally, one or more shaft support rings 159 can be placed within the camera support post 72 for stabilizing the elongate shaft 161. As depicted in FIG. 9B, a shaft support ring 159, axially aligned with the camera support post 72 and having a aperture therein, is mounted proximal the top side of the opening 170. Those skilled in the art will appreciate that other methods to pivot the elongate shaft 161 can be employed, for example a motor (such as a DC or stepper motor) coupled to the elongate shaft by belt, gears or other means.

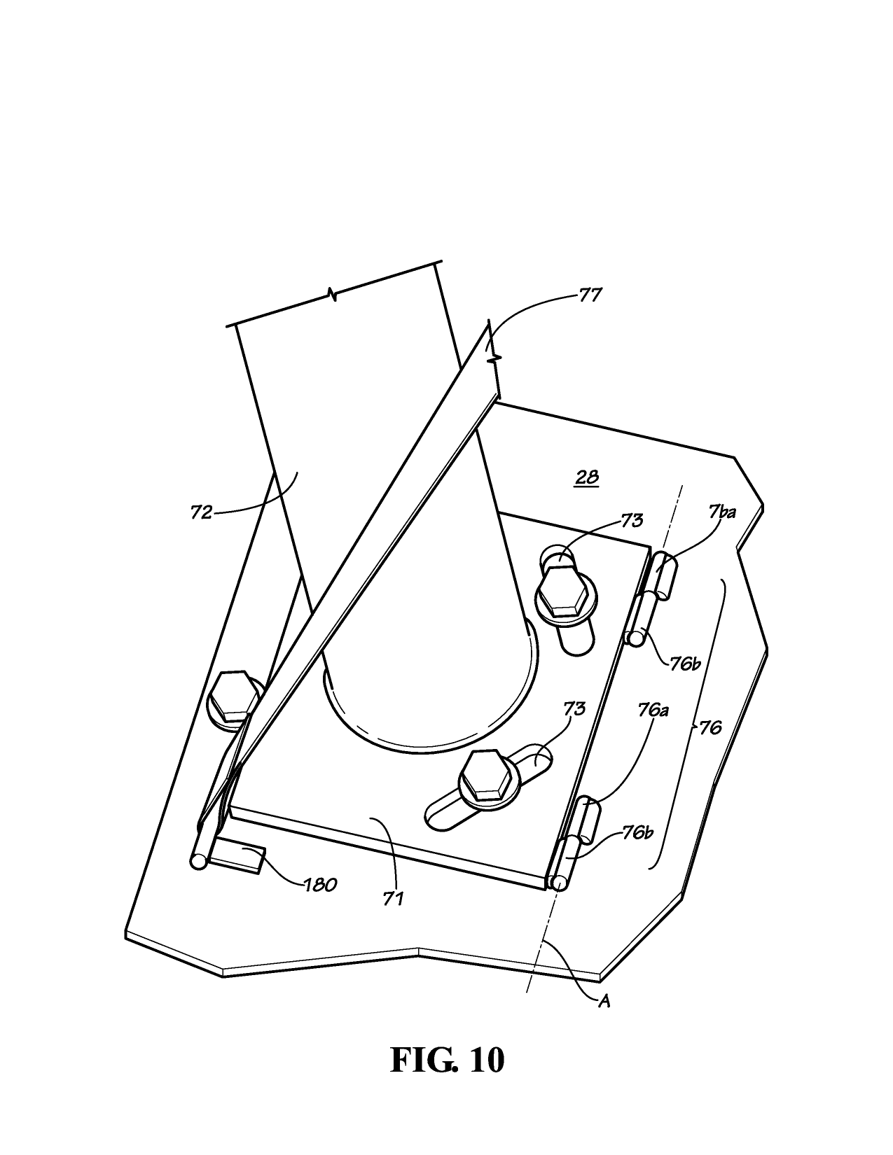

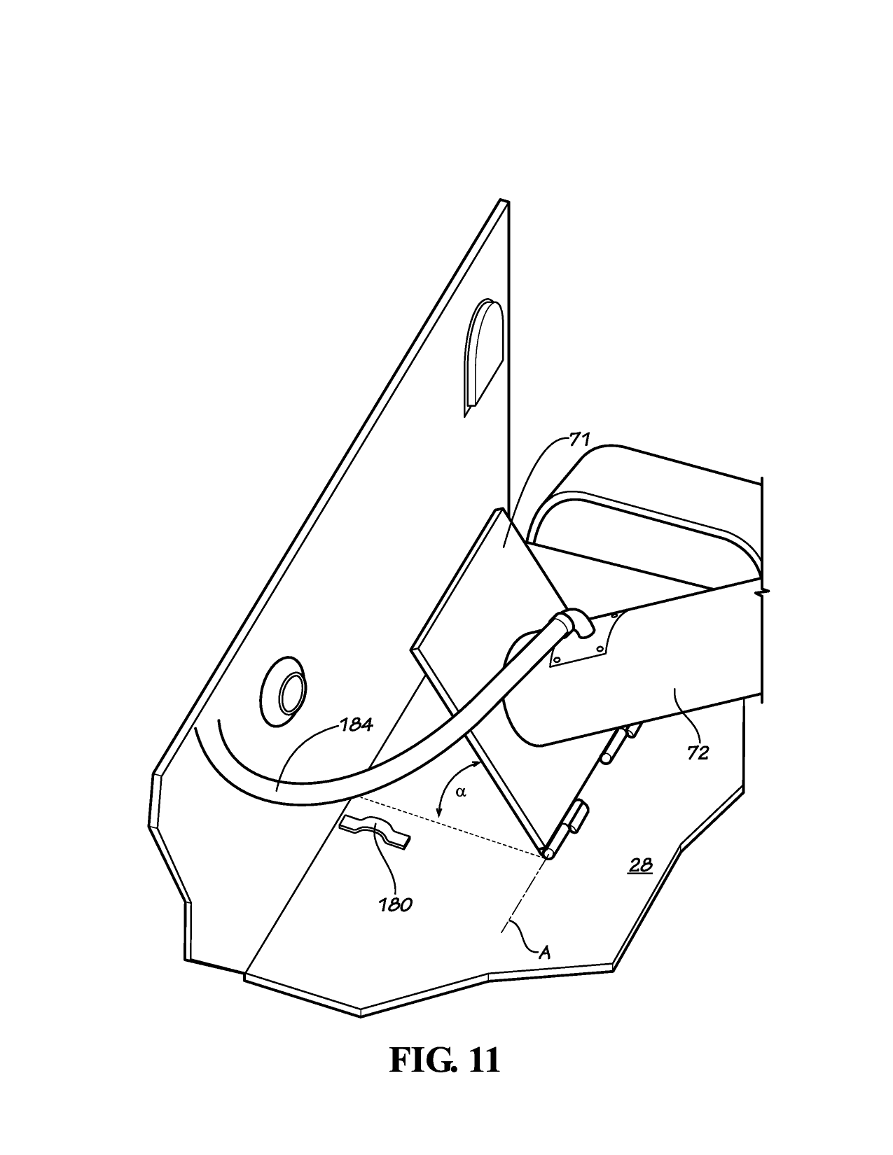

Referring now more specifically to FIGS. 10-14, the pivoting mechanism of the camera post will be explained in more detail. The camera support pole 72 is tiltably mounted atop the wheeled chassis for tilting motion between a raised position (see FIG. 10) and a lowered position (see FIG. 11). Optionally, a brace 74 extends between the wheeled chassis and the camera support pole 72 for bracing the camera support pole in position. Also optionally, a roller 75 is positioned between the camera support pole 72 and the brace 74 to allow the brace to engage the camera support pole at different positions along the camera support pole as the camera support pole is raised and/or lowered.

Preferably, one or more locks are provided for locking the camera support pole 72 in the raised position. In one form, a lock is provided for locking the camera support pole in the raised position and the lock engages and operates on the brace 74 to fix the camera support pole in position. Optionally, the lock 74 for locking the camera support pole in the raised position comprises a lock pin which engages the brace to fix the camera support pole in the raised and lowered positions.

In an example form, the camera support pole 72 is hingedly mounted relative to the wheeled chassis. Optionally, a deck is mounted to the wheeled chassis and the camera support pole 72 is hingedly mounted to the deck.

Optionally, the camera support pole is mounted to a hinge plate which in turn is hingedly mounted relative to the wheeled chassis and the trailer further includes an optional lock for locking the camera support pole in the raised position, the lock comprising a removable pin for engaging the hinge plate for locking the camera support pole in the raised position.

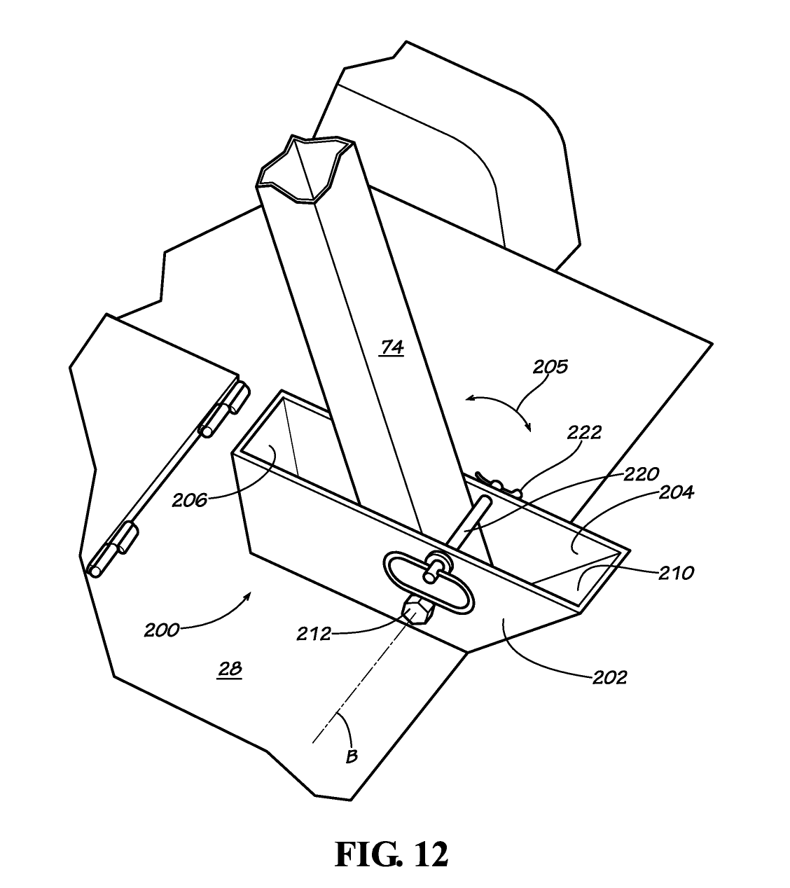

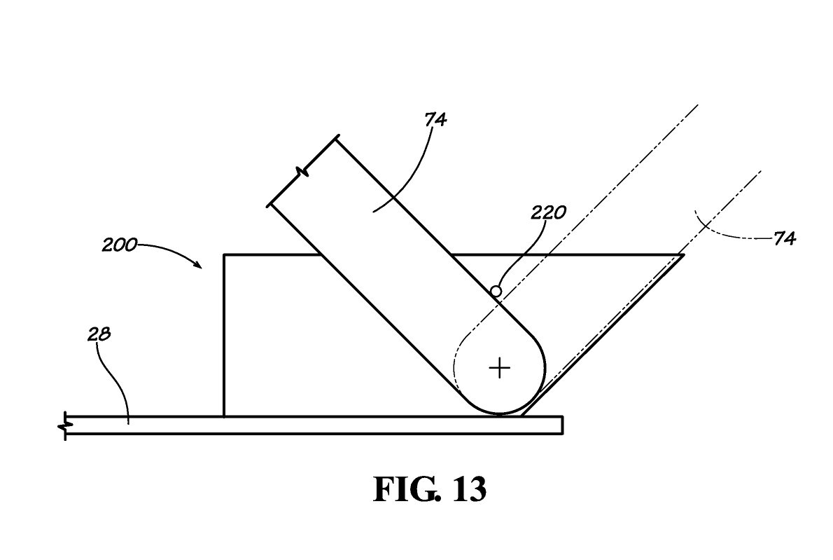

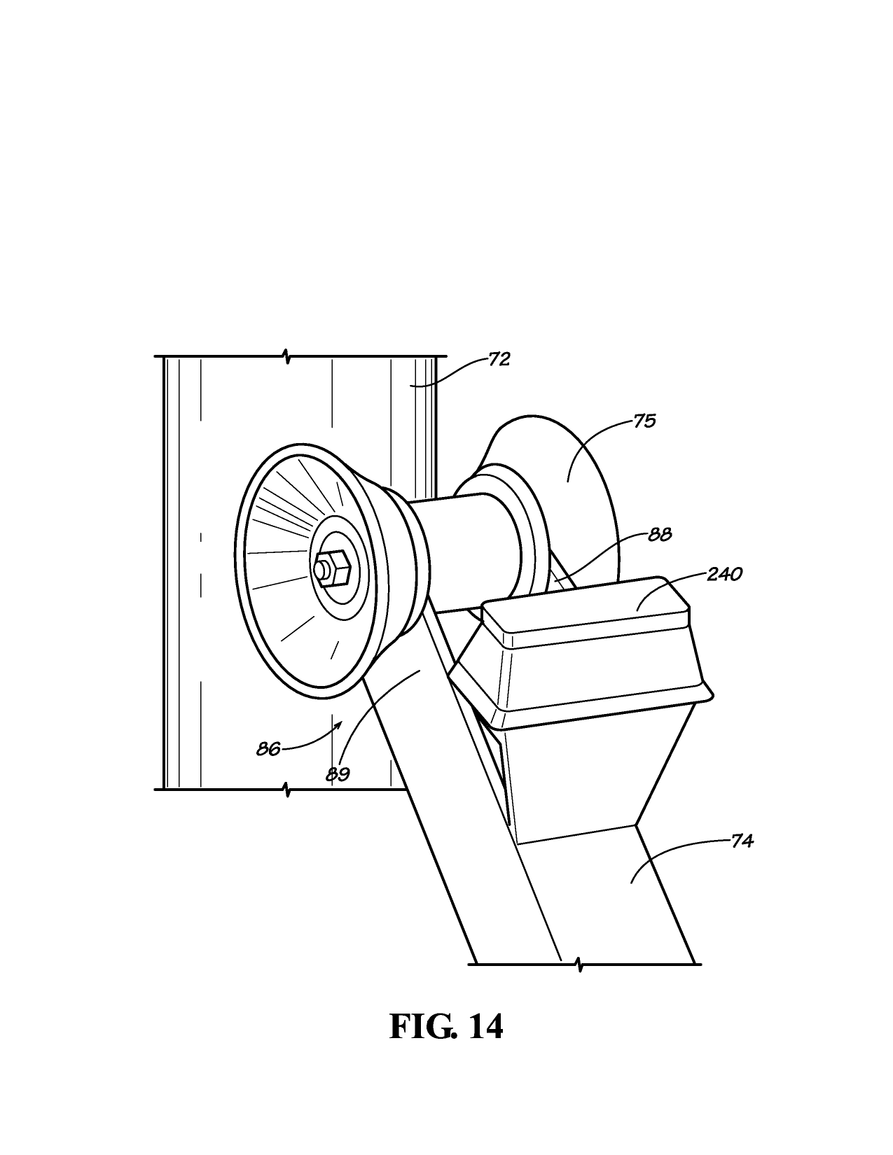

As shown in the examples of FIGS. 10-15, the support post 72 is tiltably mounted atop the wheeled chassis or deck for tilting motion between a raised position and a lowered position and a surveillance camera is mounted to the camera support post. For example, the lower portion of the camera support post 72 is attached to a plate 71 that is hingedly mounted atop the wheeled chassis or deck. The support post 72 is generally perpendicular to the plate 71 and is welded to the plate along the perimeter of the lower end of the support post. A rear side of the plate 71 is pivotally mounted to the wheeled chassis or deck by one or more hinges, such as hinge 76. The hinges partially extend along the rear side of the plate 71, wherein a deck leaf 76a is welded to the wheeled chassis or deck and a plate leaf 76b is welded to the rear side of the plate. With the plate 71 hingedly mounted to the wheeled chassis or deck, the camera support post can selectively pivot between a vertical/upright position (see FIGS. 1-2, 10, 15) when operating the surveillance system and a lowered rearward angled position (see FIGS. 5, 11) when transporting the trailer. In either position, the camera support post 72 is engaged by and stabilized by the strut 74. A first end of the strut 74 is pivotally mounted atop the chassis assembly 20 (see FIGS. 12-13) and a second end bears a roller 75 (such as a bow roller) that contacts the outer surface of the support post 72 (see FIG. 14).

FIG. 10 shows the camera support post in a vertical/upright position, wherein the plate 71 is in a substantially horizontal position and/or parallel to the common horizontal plane of the chassis assembly 20. Preferably, in addition to the strut 74, an adjustable strap 77 is attached to a ring 180 proximal the wheeled chassis or deck and further secures to the strut, thereby holding the support post in a vertical/upright position. The strap 77 can be tensioned and/or loosened appropriately by a conventional ratcheting device integrated on the strap. Alternatively, the plate 71 can comprise one or more mounting holes 73 and be removably secured to the wheeled chassis or deck by one or more bolts, screws, pins or other connectors.

FIG. 11 shows the camera support post in a lowered position, wherein the plate is positioned at an angle α relative to the wheeled chassis or deck. Preferably, the plate and the mounted camera support post pivot along a pivot axis A of the hinges 76, wherein angle α is 0° in the vertical/upright position and α is between 30°-60° in the lowered position. In additional example embodiments, the lower end of the camera support post 72 has an aperture formed therein for routing the camera mount wiring 184. Generally, the wiring is routed from the camera mount within the camera support post 72 to the lower end of the support post and travels through the aperture to further connect within the electronics enclosure. Preferably, the wiring 184 has a sufficient amount of slack between the aperture and the electronics cabinet to pivot the camera support post to the lowered position without stretching or adding tension to the wiring.

FIG. 12 shows the first end of the strut or brace 74 pivotally mounted atop the chassis assembly 20 (here attached to the deck 28). In example embodiments, the first end of the strut 74 is pivotally mounted within a trough-like socket 200 and the second end of the strut 74 engages and stabilizes the camera support post 72 in either the vertical/upright position or the lowered position. In general, the trough-like socket 200 comprises side plates 202, 204, a front end plate 206 and an angled rear end plate 210, all integrally connected to form a box-like structure. The strut 72 has a mounting hole proximal the first end which is aligned with mounting holes of the side plates 202, 204, and pivotally mounted to the socket 200 by an axle bolt or axle 212 extending through the mounting holes. The axle bolt 212 acts as a pivot axle to allow the strut to pivot about an axially aligned pivot axis B back and forth as depicted by direction arrow 205. The strut can pivot forward to an angle about 20-45° forward of vertical and can pivot rearward to an angle of about 20-50° rearward of vertical (see FIG. 13). Preferably, the lower end of the strut 74 comprises a rounded end to prevent any interference with the socket and/or chassis assembly as it pivots.

Additionally, one or more locks are provided for locking the camera support pole 72 in the raised position and lowered positions. In this regard, the side plates 202, 204 of the socket 200 further comprise aligned holes for receiving a locking pin 220 therethrough. In either position of the camera support post (raised or lowered), the locking pin 220 engages and operates on the strut 74 to fix the camera support pole in position. Note that with the camera support post 72 in a vertical orientation, the strut 74 is pivoted forwardly and the locking pin 220 is positioned behind the strut 74, locking it forward and thereby locking the camera support post upright. With the camera support post 72 in a lowered orientation, the strut 74 is pivoted rearwardly and the locking pin 220 is positioned in front of the strut 74, locking it rearward and thereby holding the camera support post in the lowered position. Additionally, a cotter pin or safety snap pin 222 can be inserted into the end of the locking pin 220 to prevent the locking pin from disengaging from within the mounting holes.

FIG. 14 shows the second (upper) end of the strut 74 engaging the camera support post 72. The upper end of the strut 74 comprises a yoke-like end 86 having a pair of flanges 88, 89 extending along two sides of the roller 75 rotatably mounted thereto. In either position of the camera support post or as the post is transitioning between one of the two positions, the roller 75 maintains engagement with the camera support post. Additionally, the adjustable strap 77 can be used to further secure the second end of the strut 74 to the support post 72. Optionally, a running light or brake light 90 can be mounted to the strut 74 just below the roller 75. Preferably, the brake light is positioned to provide a clear view to following traffic when the support post is in the lowered position.

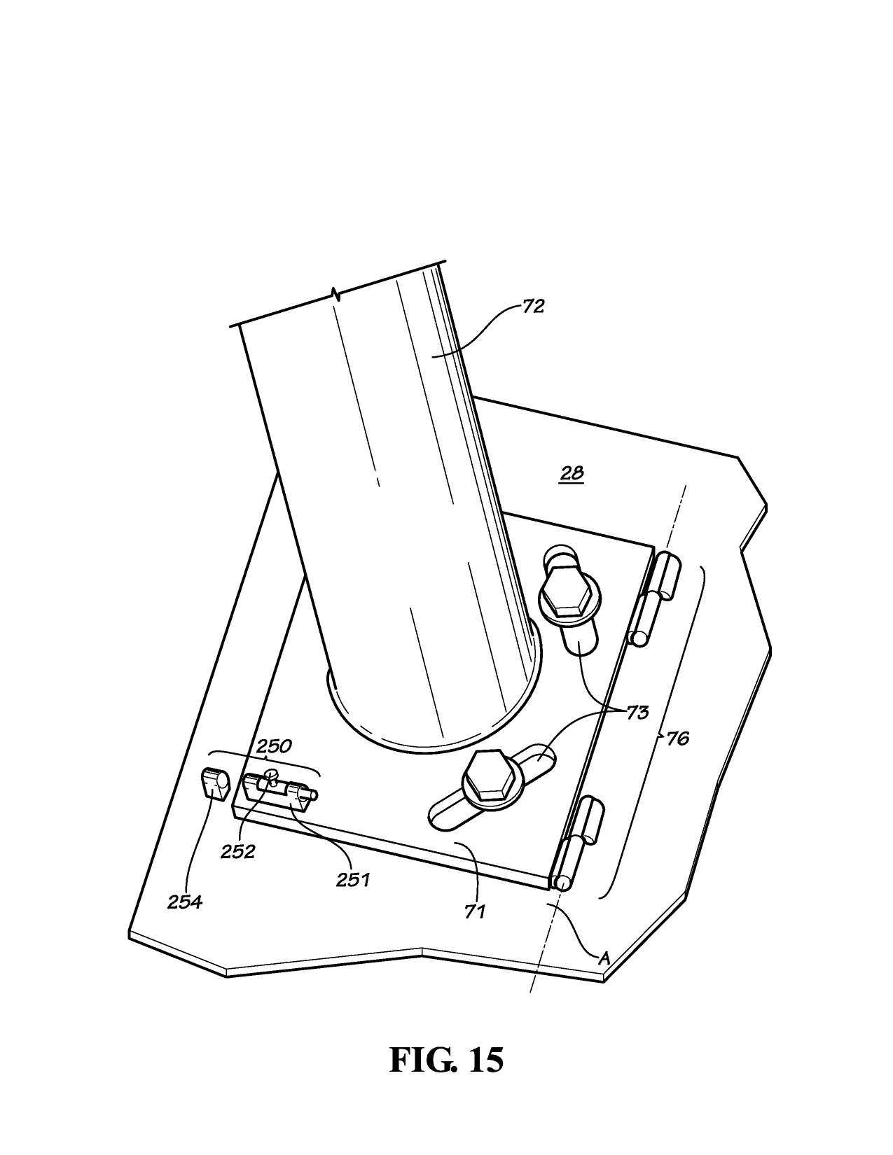

FIG. 15 shows an alternate example embodiment of an optional lock 250 for locking the camera support post 72 in the vertical/upright position. In general, the lock 250 is a three-piece lock comprising a first housing 251, a movable piece or pin 252 slidably mounted within the first housing 251 for engaging and disengaging a second housing 254. Preferably, one of the two housings is mounted to the wheeled chassis or deck and the other piece is mounted to the plate 71.

While the invention has been shown and described in exemplary forms, it will be apparent to those skilled in the art that many modifications, additions, and deletions can be made therein without departing from the spirit and scope of the invention as defined by the following claims.

What is claimed is:

1. A surveillance trailer, comprising:
a wheeled chassis for selective movement over and resting atop the ground;
surveillance electronics, including a portable power supply;
a camera support pole tiltably mounted relative to the wheeled chassis for tilting motion between a raised position for deployment and use and a lowered position for transport; and
a surveillance camera mounted to the camera support pole.

2. A surveillance trailer as claimed in claim 1 further comprising a brace for bracing the camera support pole in position.

3. A surveillance trailer as claimed in claim 2 further comprising a resilient roller positioned between the camera support pole and the brace to allow the brace to engage the camera support pole at different positions along the camera support pole as the camera support pole is raised and/or lowered.

4. A surveillance trailer as claimed in claim 1 further comprising a lock for locking the camera support pole in the raised position.

5. A surveillance trailer as claimed in claim 2 further comprising a lock for locking the camera support pole in the raised position and wherein the lock engages and operates on the brace to fix the camera support pole in position.

6. A surveillance trailer as claimed in claim 5 wherein the lock for locking the camera support pole in the raised position comprises a lock pin which engages the brace to fix the camera support pole in the raised and lowered positions.

7. A surveillance trailer as claimed in claim 1 wherein the camera support pole is hingedly mounted relative to the wheeled chassis.

8. A surveillance trailer as claimed in claim 7 further comprising a deck mounted to the wheeled chassis and wherein the camera support pole is hingedly mounted to the deck.

9. A surveillance trailer as claimed in claim 8 further comprising a lock for locking the camera support pole in the raised position, the lock comprising a removable pin for locking the camera support pole in the raised position.

10. A self-contained surveillance trailer as claimed in claim 1 wherein the camera support pole is mounted to a hinge plate which in turn is hingedly mounted relative to the wheeled chassis and further comprising a lock for locking the camera support pole in the raised position, the lock comprising a removable pin for engaging the hinge plate for locking the camera support pole in the raised position.

11. A self-contained surveillance trailer, comprising:
a wheeled chassis for selective movement over and resting atop the ground;
an electronics enclosure mounted atop the wheeled chassis;
surveillance electronics, including a portable power supply, at least some of which is mounted within the electronics enclosure;
a camera support pole tiltably mounted atop the wheeled chassis for tilting motion between a raised position and a lowered position; and
a surveillance camera mounted to the camera support pole.

12. A self-contained surveillance trailer as claimed in claim 11 further comprising a brace extending between the wheeled chassis and the camera support pole for bracing the camera support pole in position.

13. A self-contained surveillance trailer as claimed in claim 12 further comprising a roller positioned between the camera support pole and the brace to allow the brace to engage the camera support pole at different positions along the camera support pole as the camera support pole is raised and/or lowered.

14. A self-contained surveillance trailer as claimed in claim 11 further comprising a lock for locking the camera support pole in the raised position.

15. A self-contained surveillance trailer as claimed in claim 12 further comprising a lock for locking the camera support pole in the raised position and wherein the lock engages and operates on the brace to fix the camera support pole in position.

16. A self-contained surveillance trailer as claimed in claim 15 wherein the lock for locking the camera support pole in the raised position comprises a lock pin which engages the brace to fix the camera support pole in the raised and lowered positions.

17. A self-contained surveillance trailer as claimed in claim 11 wherein the camera support pole is hingedly mounted relative to the wheeled chassis.

18. A self-contained surveillance trailer as claimed in claim 11 further comprising a deck mounted to the wheeled chassis and wherein the camera support pole is hingedly mounted to the deck.

19. A self-contained surveillance trailer as claimed in claim 11 further comprising a lock for locking the camera support pole in the raised position, the lock comprising a removable pin for locking the camera support pole in the raised position.

20. A self-contained surveillance trailer as claimed in claim 11 wherein the camera support pole is mounted to a hinge plate which in turn is hingedly mounted relative to the wheeled chassis and further comprising a lock for locking the camera support pole in the raised position, the lock comprising a removable pin for engaging the hinge plate for locking the camera support pole in the raised position.
